(19) United States
(12) Patent Application Publication
(10) Pub. No.: US 2007/0282965 A1
(43) Pub. Date: Dec. 6, 2007

(54) METHOD FOR SHARING COMMUNICATION INFORMATION USING LOCAL PROXY

(76) Inventor: Katsuhisa Kataoka, Sagamihara-shi (JP)

Correspondence Address: IBM CORPORATION;INTELLECTUAL PROPERTY LAW, 11400 BURNET ROAD, AUSTIN, TX, 78758, US

(21) Appl. No.: 11/752,970

(22) Filed: May 24, 2007

(30) Foreign Application Priority Data
May 30, 2006 (JP) 2006-149356

(51) Int. Cl. G06F 15/167; G06F 15/173

(52) U.S. Cl. 709/213; 709/223

(57) ABSTRACT

A method for sharing communication information using a local proxy that operates in the same process as a browser operating on a terminal. A method includes a local proxy that operates on a terminal operating as a proxy for communication between an application operating on the terminal and a server, the local proxy operating in a browser process space on the terminal. An application operating in a separate process transmits data to the local proxy which transmits the data through the browser to the server. The local proxy receives processed data from the server through the browser, and transmits the processed data to the application.

### FIELD OF THE INVENTION

The present invention relates to a method, a system, and a program product for sharing communication information using a local proxy operating in a process including of a browser operating on a client (hereinafter, also referred to as a terminal) in a client-server system operated by a network application.

### BACKGROUND

Single sign-on systems, in which a user authentication proxy that performs user authentication for a Web site is arranged between a user terminal accessing a Web server through the Internet and the Web server, have been previously described (for example, Japanese Unexamined Patent Application Publication No. 2002-32340). That system enables the user authentication proxy to perform user authentication for the Web site specified by a user regardless of kind of the user terminal.

On the other hand, software known as a “local proxy” allows a terminal to have a proxy function within the terminal itself. The local proxy is typically used in the following way. If a browser sends a request for data to the local proxy, the local proxy requests the data from the Web server in place of the browser. In addition, the local proxy receives the data transmitted from the Web server, and transmits the data to the browser. With such a usage, the data transmitted from the Web server can be transmitted to the browser after modifying the data according to the user's preferences. For example, elimination of advertisements, disabling of JavaScript®, disabling of auto reload, or the like can be realized.

Business applications developed as Web systems, often integrate company authentication information. In Web systems, it is assumed that terminal processing is performed using a browser. In Web systems most logical processing is commonly performed on the server side. A browser receives processing results from a WWW (World Wide Web) server using HTTP (HyperText Transfer Protocol), and displays the processing results. By assuming the use of browser and communication using HTTP, companywide integrated authentication across a plurality of applications can be implemented. More specifically, by attaching authentication information to data in a format processable by the browser, such as a cookie, between the browser and an authentication server, the browser can automatically attach the authentication information to the communication stream of each application. Accordingly, each application does not need to perform special processing regarding authentication.

### SUMMARY OF THE INVENTION

Using a browser for an application interface creates problems because input operations of the browser user interface are often poor and certain complex operations cannot be performed such as assignment of function keys and a return key. For this reason, there are business fields for which application implementation using a browser is not suitable.

One alternative is the use of a technique called rich client. The rich client is a technique for realizing a “rich”or enhanced client by using techniques, for example, Web browser plug-ins, to improve expression ability and operability of the user interface. The rich client provides a unique runtime environment and operates in an application specific to each technique. Accordingly, there is a trend for business fields for which implementation using a browser is not suitable to use the rich client technique.

The rich client technique is often incorporated in a browser and can be executed using the browser. This means that the rich client operates in a process space of the browser. With such a configuration, it is possible to share communication information that the browser has and to utilize integrated authentication.

However, it is difficult to enable a plurality of different versions of runtime environments of the rich client to operate in parallel in a single process of a browser. Business applications customers often desire to use an application in a finished version that may not have changed for months or years. However, when applications using the rich client technique and developed at different times exist, it is impossible to operate the applications in a single process of a browser unless the runtime versions are integrated to a single one of the runtime versions.

Alternatively, it is possible to operate a plurality of versions of applications if the applications are not incorporated in a single process of the browser but different process space is provided for each application. However, in this case, information used for authentication (cookie or the like) cannot be shared among the activated applications and the browser. For this reason, a user authentication is required again in each of the activated applications. Thus, in this case, even using a method described above, common authentication cannot be provided. As a result, use of rich clients in separate processes is not acceptable to customers who require common authentication. Implementation of common authentication in this case requires development of a separate authentication application which may be costly and may decrease the usability of the application.

An examination of an implementation that allows a rich client to take over authentication information from a browser at the time of activation of the rich client by some means could be considered. However, this implementation of taking over the authentication information is performed not in a general method but in a significantly special method, which may be costly to implement. In addition to this, for example, this implementation cannot cope with a system that updates the authentication information at regular intervals after the activation.

Accordingly, the present invention focuses on a local proxy that operates in a browser, and relays the communications of other applications. Based on this idea, an object of the present invention is to configure applications operating in other processes on a terminal to perform communication through a browser which limits the communication path with a server to a single communication path.

According to a first embodiment of the present invention, a method for sharing communication information in a client-server system operated by a network application is provided. The method is characterized by including a local proxy that operates on a client, as a proxy for communication between an application operating on the client and a server. In a process similar to a process of a browser operating on the client, the application operating in a process different from the process of the local proxy, the local proxy receives data transmitted by the application, and transmits the data through the browser to the server, and the local proxy receives processed data from the server through the browser, and transmitting the processed data to the application.

The local proxy may be implemented in an implementation method that allows the local proxy to operate in a process similar to that of the browser and to perform TCP/IP socket communication of that process. For example, the local proxy can perform communication using HTTP. In addition, implementation of the local proxy can be realized using ActiveX®, or a runtime environment such as a Java® Runtime Environment (hereinafter, referred to as Java Runtime Env.) or can be realized as originally written software.

A process according to the preferred embodiment of the present invention means a program to which a memory space is assigned by an Operating System and that performs processing.

According to a second embodiment, a system for sharing communication information in a client-server system operated by a network application is provided. The system is characterized by including a browser that operates on a client, and a local proxy that operates on the client, the local proxy operating as a proxy for communication between an application operating on the client and a server, in the same process as a browser operating on the client. The application operates in a process different from the process of the local proxy. The local proxy includes a data receiving unit for receiving data transmitted by the application, a data transmitting unit for transmitting the data to the server, a processed data receiving unit for receiving processed data from the server, and a processed data transmitting unit for transmitting the processed data to the application.

According to a third embodiment of the present invention a computer program product for causing a computer to execute a method for sharing communication information in a client-server system operated by a network application is provided. The method includes a local proxy that operates on a client operating as a proxy for communication between an application operating on the client and a server, in the same process as a browser that operates on the client, the application operating in a process different from the process of the local proxy, the local proxy receiving data transmitted by the application, and transmitting the data to the server, and the local proxy receiving processed data from the server, and transmitting the processed data to the application.

Similarly, when an application operating in still another process communicates with a server, the similar advantage can be realized by transmitting data to the local proxy.

According to the present invention, it is possible to redirect communication in a terminal to a browser and limit the path of the communications with a server to one communication path by implementing a local proxy that relays the communications of applications operating in other processes. Accordingly, authentication information can be shared using the browser among a plurality of applications. As a result, both a function of realizing single sign-on and a function of improving operability using a rich client can be provided.

Furthermore, according to the present invention, by providing a local proxy that operates in a process similar to a browser allowing general use, the method can be used in a system using various plug-ins or techniques. Additionally, by limiting the communications performed by the local proxy to those in the same terminal security can be ensured.

Moreover, according to the present invention, even regarding an existing application that performs reauthentication at the time of connection to a server, the runtime environment can be shifted to a desired version of runtime environment by limiting a source of requests, which the local proxy operating in the process similar to that of the browser relays, to a local host. Accordingly, changes necessary for this method can be suppressed to a significant extent, and the runtime environment can be easily shifted to the desired version of runtime environment.

### BRIEF DESCRIPTION OF THE DRAWINGS

FIG. 1 is a diagram showing a known authentication method.

FIG. 2 is a diagram showing an authentication method in which the present invention is used.

FIG. 3 is a functional block diagram of a terminal.

FIG. 4 is a diagram showing a hardware configuration of a terminal.

FIG. 5 is a flowchart showing processing in a terminal.

FIG. 6 is an implementation example in which the present invention is used.

FIG. 7 is an implementation example in which the present invention is used.

FIG. 8 is an implementation example in which the present invention is used.

FIG. 9 is a diagram showing a client-server system according to the present invention.

### DETAILED DESCRIPTION

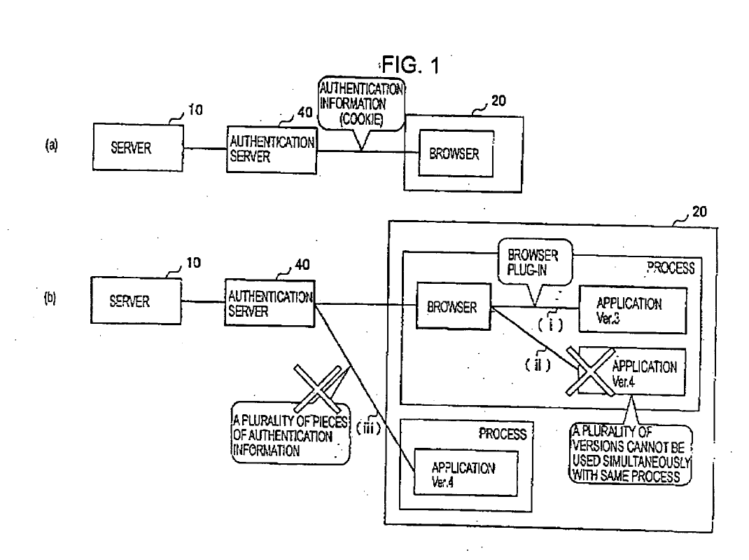

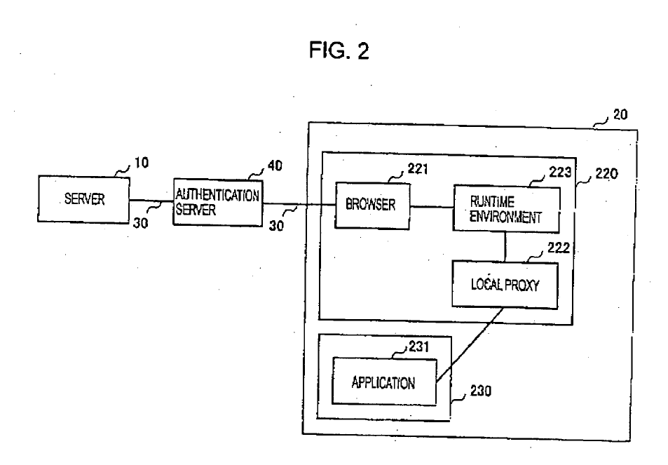

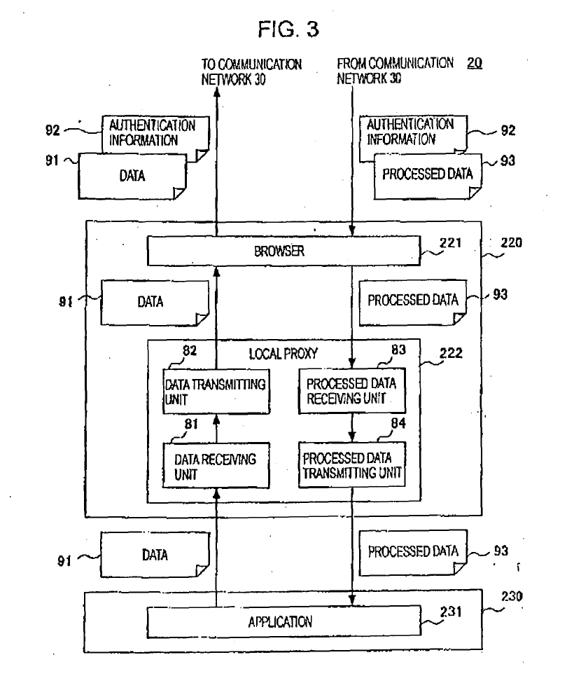

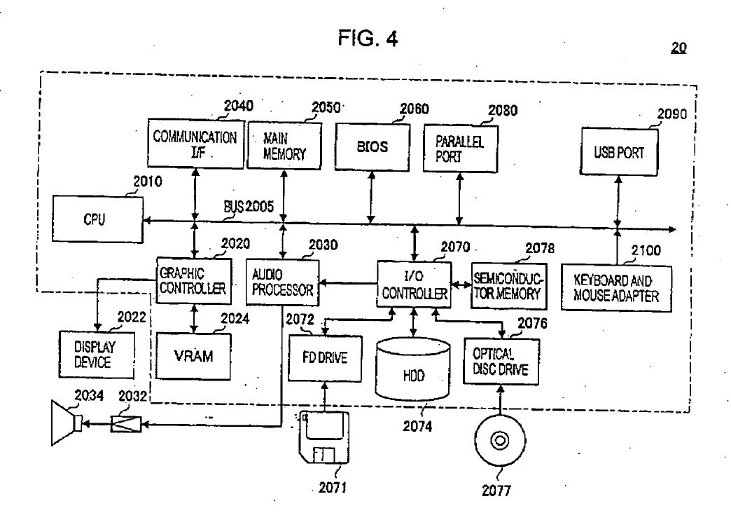

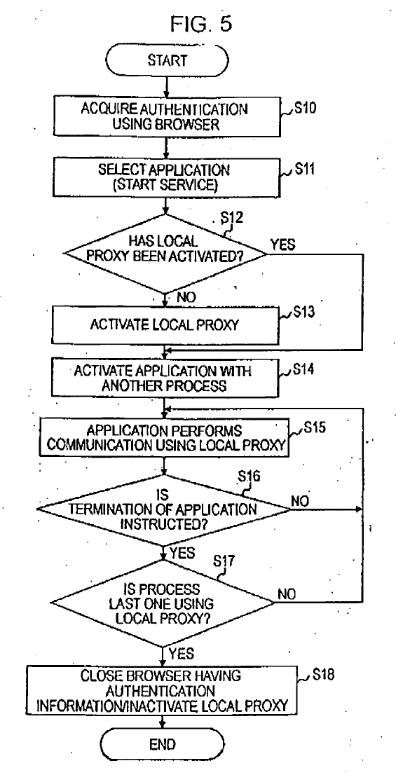

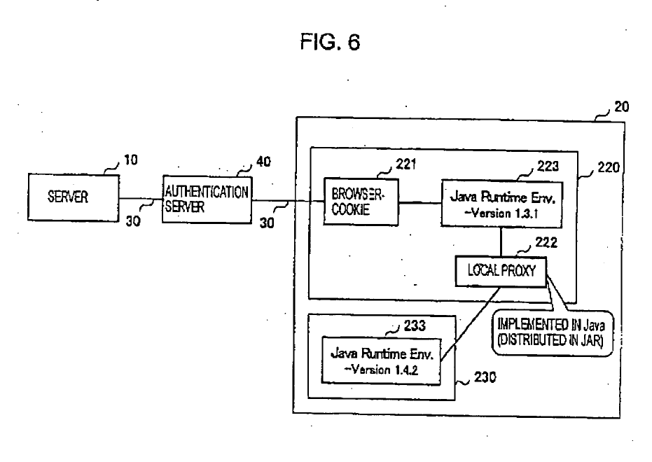

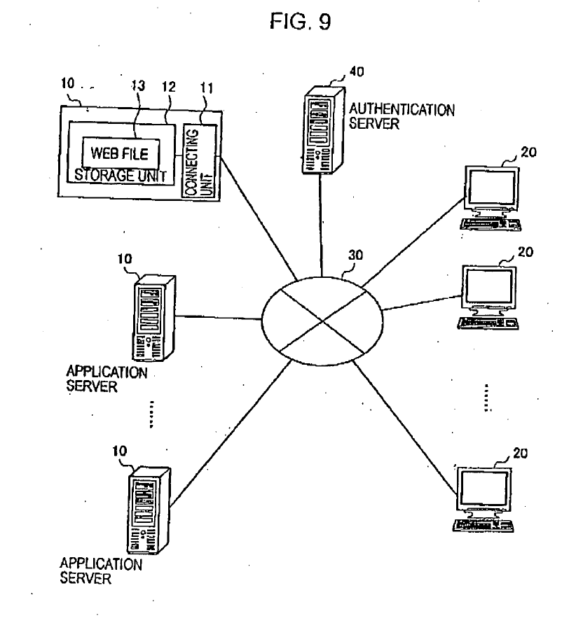

In the following, an example of preferred embodiments of the present invention will be described with reference to the drawing. FIG. 1 is an example of a known authentication method. FIG. 2 is an example of an authentication method according to the present invention. FIG. 3 is a functional block diagram of a terminal in the present invention. FIG. 4 is a diagram showing a hardware configuration of a terminal. FIG. 5 is an example of a flowchart of processing in a terminal. FIGS. 6 to 8 are implementation examples in which the present invention is used. FIG. 9 is a client-server system operated by a network application according to an embodiment of the present invention.

FIG. 1 shows an example of a known authentication method. In FIG. 1(a), communication with a server 10, i.e., an application server, is performed by attaching cookie authentication information to data between a browser operating on a terminal 20 and an authentication server 40. Accordingly, the browser automatically attaches the cookie authentication information to the data communicated with the server 10, thereby a single sign-on system can be realized utilizing the browser in a browser-based application system.

On the other hand, FIG. 1(b) is a diagram showing an example of an authentication method when a plurality of versions of applications are used in a terminal 20. To activate an application with an operation through a browser, an application stored in a server 10, which is an application server, is loaded to the terminal 20 using a browser plug-in in the process similar to that of the browser and the application is activated on the client. By using such a technique, a “rich” client that uses a technique for improving expression ability and operability of an interface can be realized. Communication between the terminal 20 and the server 10 is authenticated by an authentication server 40 through a browser on the terminal 20 (see (i) in FIG. 1(b)).

However, using different versions of applications at the same time in the process similar to that of the browser on the terminal 20 is difficult due to compatibility issues (see (ii) in FIG. 1(b)). In addition, an application is activated in a process other than that of the browser on the terminal 20, the authentication information authenticated by the authentication server 40 through the browser on the terminal 20 cannot be used. Thus, a necessity of reauthentication occurs for communication between the application in the terminal 20 and the server 10 (see (iii) in FIG. 1(b)).

FIG. 2 is a diagram showing an example of an authentication method according to the present invention that solves problems shown above in FIG. 1(b). A local proxy 222 is implemented in a process 220 including a browser 221 in a terminal 20 using a runtime environment 223. In an application 231 that is activated in a process 230, which is a process other than the process 220, the local proxy 222 is specified as a transmission destination beforehand. Once the application 231 is activated, the application 231 performs transmission of data to the local proxy 222. The local proxy 222 performs communication with a server 10 through the browser 221. Then, the local proxy 222 receives data transmitted from the server 10 through the browser 221, and transmits the data to the application 231. As a result, even when the application 231 is used, communication between the terminal 20 and the server 10 can be performed through the browser 221, and the authentication information having been already authenticated by the authentication server 40 can be used. Accordingly, when the terminal 20 communicates with the server 10, the application 231 sets the transmission destination of the data to the local proxy 222 residing in the process 220 similar to that of the browser 221, whereby the authentication information between the terminal 20 and the server 10 can be shared.

Here, the implementation of the local proxy 222 can be realized by downloading the local proxy 222 from the server 10. With use of this method, even if the runtime environment 223 in the process 220 including the browser 221 is modified by version up or the like, the local proxy is provided from the server 10 each time without user performing troublesome operations. Thus, the local proxy 222 can be implemented in a relatively easy way for distribution and execution.

In addition, a method for activating the application 231 in another process 230 is established as an existing technique. For example, there is a technique such as “Bootstrap Applet”. Here, the “Bootstrap Applet” is an applet for activating the application, which operates directly on an OS on which the browser operates, using an applet that can be easily distributed over the Internet as a bootstrap. More specifically, in response to an application activation request in the client, a runtime environment confirmation applet for confirming the runtime environment loaded from the server is executed. On the basis of the execution result, an activation command loaded from the server together with the application is executed in the client, whereby activation of the application is realized.

FIG. 3 shows a functional block diagram of the terminal 20 according to the present invention. The terminal 20 has the process 220, including the browser 221 and the local proxy 222, and the process 230, other than the process 220, including the application 231. The description will be given while assuming that the authentication between the browser 221 and the server 10 (not shown) has already been established.

The application 231 transmits data 91 to the local proxy 222 to perform communication with the server 10.

A data receiving unit 81 of the local proxy 222 receives the data 91, and takes the data 91 over to a data transmitting unit 82.

The data transmitting unit 82 receives the data 91 from the data receiving unit 81, and transmits the data 91 to the browser 221.

The browser 221 transmits the data 91 and authentication information 92 for the server 10 to the server 10 through a communication network 30 on the basis of the general communication.

On the other hand, after processed data 93 is transmitted to the browser 221 together with the authentication information 92 from the server 10 through the communication network 30, the browser 221 transmits the processed data 93 to the local proxy 222.

A processed data receiving unit 83 of the local proxy 222 receives the processed data 93, and takes the processed data 93 to a processed data transmitting unit 84.

The processed data transmitting unit 84 receives the processed data 93 from the processed data receiving unit 83, and transmits the processed data 93 to the application 231.

As described above, with use of each function of the local proxy 222, even the application 231 in the process 230 different from the process 220 including the browser 221 can perform communication with the server 10 using a communication function of the browser 221.

FIG. 4 shows an example of a hardware configuration of the terminal 20. The terminal 20 includes a CPU (Central Processing Unit) 2010, a bus 2005, a communication I/F 2040, a main memory 2050, a BIOS (Basic Input Output System) 2060, a parallel port 2080, a USB port 2090, a graphic controller 2020, an audio processor 2030, an I/O controller 2070, and a keyboard and mouse adaptor 2100. Storage means, such as an FD (flexible disk) drive 2072, a hard disk 2074, an optical disc drive 2076, and a semiconductor memory 2078, can be connected to the I/O controller 2070.

An amplification circuit 2032 and a speaker 2034 are connected to the audio processor 2030. In addition, a VRAM 2024 and a display device 2022 are connected to the graphic controller 2020.

The BIOS 2060 stores a boot program that the CPU 2010 executes at the time of activation of the terminal 20 and hardware-dependent programs depending on hardware of the terminal 20. The FD drive 2072 reads data from a flexible disk 2071, and supplies the data to the hard disk 2074 through the I/O controller 2070.

For example, a DVD-ROM drive, a CD-ROM drive, a DVD-RAM drive, or a CD-RAM drive can be used as the optical disc drive 2076. In this case, it is necessary to use an optical disc 2077 corresponding to each drive. The optical disc drive 2076 reads programs or data from the optical disc 2077, and may supply the program or the data to the main memory 2050 or the hard disk 2074 through the I/O controller 2070.

Computer programs supplied to the terminal 20 may be stored on a recording medium such as the optical disc 2077 or a memory card (not shown) and provided by a user. In such a case, the computer programs are read out from the recording medium through the I/O controller 2070, thereby being installed in the terminal 20 and executed. In addition, the computer programs are downloaded through the communication I/F 2040, thereby being installed in the terminal 20 and executed.

The above-described hardware configuration of the terminal 20 is only an example, and all of the above-described elements may not be necessarily required.

FIG. 5 is a flowchart showing processing in the terminal 20, and shows an example of activation/termination processing when the local proxy 222 is used.

Firstly, at STEP S10, by launching the browser 221 in the terminal 20 and specifying a URL (Uniform Resource Locator) of the server 10, where an information source resides, through the browser 221, the CPU 2010 of the terminal 20 transmits a connection request to the server 10. The server 10 transfers the processing to the authentication server 40 to confirm that the terminal 20 is a terminal having a permission of the connection. The authentication server 40 performs the authentication processing. Upon the authentication server 40 authenticating the terminal 20 correctly, the communication between the server 10 and the terminal 20 is established (STEP S10).

For example, if a user clicks a button on a page of the browser 221 to request activation of the application 231, the CPU 2010 of the terminal 20 accepts the activation request of the application 231 (STEP S11). Then, the CPU 2010 advances the process to STEP S12.

After advancing the process to STEP S12, the CPU 2010 determines whether or not the local proxy 222 has been activated (STEP S12). This determination processing is implemented by a technique used for activation of the application 231. For example, in case of HTML, the determination processing can be implemented using JavaScript®.

At STEP S12, if the local proxy 222 has not been activated (if NO is selected at STEP S12), the CPU 2010 advances the process to STEP S13 to activate the local proxy 222. On the other hand, at STEP S12, if the local proxy 222 has been activated (if YES is selected at STEP S12), the CPU 2010 advances the process to STEP S14.

After advancing the process to STEP S13, the CPU 2010 activates the local proxy 222 (STEP S13). More specifically, the CPU 2010 confirms whether or not the local proxy 222 resides in the hard disk 2074 of the terminal 20. If the local proxy 222 does not reside in the hard disk 2074, or if the version of the local proxy 222 is old, the CPU 2010 requests downloading of the local proxy 222 from the server 10. The CPU 2010 then stores the local proxy 222 downloaded through the communication I/F 2040 in the hard disk 2074, and loads the local proxy 222 to the main memory 2050. The CPU 2010 activates the local proxy 222 loaded to the main memory 2050. If the local proxy 222 is stored in the hard disk 2074, the CPU 2010 loads the local proxy 222 to the main memory 2050, and activates the local proxy 222 loaded to the main memory 2050. Then, the CPU 2010 advances the process to STEP S14.

After advancing the process to STEP S14, the CPU 2010 activates the application 231 in a process 230 other than the process of the browser 221 (STEP S14). The CPU 2010 then advances the process to STEP S15.

After advancing the process to STEP S15, the application 231 performs communication with the server 10 using the local proxy 222 (STEP S15). More specifically, the communication is performed in a manner as described in FIG. 3. By means of these series of processing, the application 231 in the process other than that of the browser 221 can communicates with the server 10 using the authentication function of the browser 221.

When a user terminates the application 231 (if YES is selected at STEP S16), the CPU 2010 determines whether or not the process of the application 231 is the last process that uses the local proxy 222 (STEP S17). If another application is using the local proxy 222 (if NO is selected at STEP S17), the CPU 2010 advances the process to STEP S15. On the other hand, if there is no other application using the local proxy 222 (if YES is selected at STEP S17), the CPU 2010 advances the process to STEP S18.

After advancing the process to STEP S18, the CPU 2010 closes the browser 221, and terminates the local proxy 222 (STEP S18).

As implementation examples, the following examples can be given.

FIG. 6 is a conceptual diagram in which the present invention is used when the local proxy 222 activated in the process 220 of the browser 221 is implemented using Java®. The terminal 20 includes a process 230 that is a process different from the process 220 in which the browser 221 and the local proxy 222 operate. The local proxy 222 is implemented using the runtime environment 223, Java Runtime Env.-Version 1.3.1. In the process 230, the application 231 (not shown) using the runtime environment 233 of the version different from that of the runtime environment 223 can operate.

In this case, the application 231 activated in the process 230 different from the process 220 can be implemented in any way as long as the technique allows the communication with the local proxy 222. The same applies to a case in which the local proxy 222 is implemented using other techniques. In addition, needless to say, the process 220 in which the browser 221 operates and the process 230 that is a process different from the process 220 may have the same version of runtime environment.

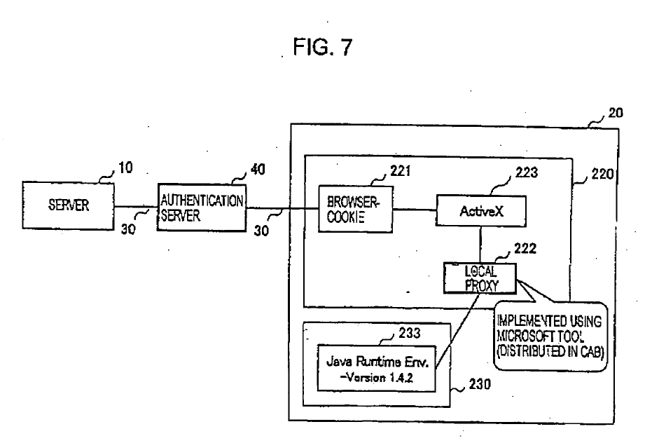

FIG. 7 is a conceptual diagram regarding a case in which the local proxy 222 activated in the process 220 of the browser 221 is implemented using ActiveX®, i.e., a Microsoft tool.

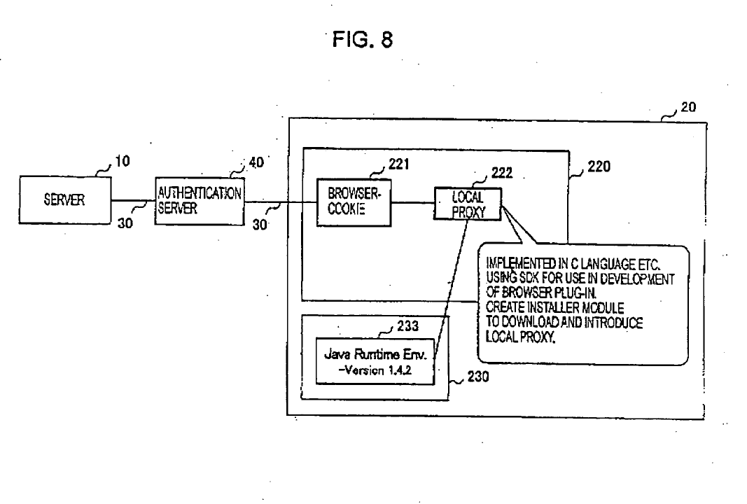

Furthermore, FIG. 8 is a conceptual diagram regarding a case in which the local proxy 222 activated in the process 220 of the browser 221 is implemented using a tool for use in development of a plug-in of the browser 221.

FIG. 9 is a schematic diagram of a client-server system according to an embodiment of the present invention. In FIG. 9, servers 10 are application servers. The server 10 has a connecting unit 11 for connecting to a communication network 30 and a storage unit 12 for storing programs. In addition, the storage unit 12 stores Web files 13. The Web file 13 contains contents for WWW and application files. Regarding authentication between the server 10 and a terminal 20, the system may have an authentication function with an authentication server 40 connected through the communication network 30 or may have an authentication function by providing an authentication unit (not shown) in the server 10.

For example, the terminal 20 can download information in the Web file 13 from the server 10, and display the contents therein using a browser.

The communication network 30 is a network such as the Internet or an intranet, and connects the servers 10 and the terminals 20. The communication network 30 may be a WAN (Wide Area Network) or may be a LAN (Local Area Network).

In addition, the information in the Web file 13 registered in the server 10 is constituted by page data to be displayed as a Web page by the browser and a application or the like. The page data is written in, for example, HTML (HyperText Markup Language). The application includes server-side programs such as JSP (JavaServer® Pages), Java® Servlet, and ASP (Active Server Pages), Java® applet, ActiveX® control, and browser plug-ins, more specifically.

While embodiments have been described above, regarding the communication by the local proxy, the local proxy allows only communications whose connection source is from the terminal in socket communications, whereby communications are limited to those from applications in the same terminal. Thus, security can be ensured.

Furthermore, when applications of the existing system is shifted into a system employing the present invention, the local proxy is activated in the process similar to that of the browser, and the transmission destination of the communication of the existing application is changed to the local proxy, thereby enabling the implementation.

In the above, a method and a system for sharing the communication information using a local proxy that operates on a browser in a client have been mainly described. However, a function similar to the above-described method for sharing the communication information of the application can be realized by installing a program having a function described in the method for sharing the communication information of the application in a computer, and causing the computer to execute the method. Accordingly, the method for sharing the communication information of the application described as one embodiment of the present invention can be realized by a computer program. Needless to say, the present invention includes not only the program itself but also a program product including a medium storing the program within the scope thereof. The program for executing the function of the present invention can be stored in any computer readable medium, such as a flexible disk, an MO, a CD-ROM, a DVD, a hard disk drive, a ROM, an MRAM, and a RAM. Such a program may be downloaded from another computer system connected to a communication network, or may be copied from another medium to store the program on a computer readable medium. In addition, such a program may be compressed or divided into a plurality of programs and stored on a single or a plurality of recording media.

While the present invention has been described using embodiments and examples, the technical scope of the present invention is not limited to the scope described in the above embodiments. Various modifications or improvements can be added to the above-described embodiments. It is obvious from the appended claims that such modifications or improvements can be also included within the technical scope of the present invention.

What is claimed is:

1. A method for sharing communication information in a client-server system operated by a network application, comprising:
operating a local proxy on a client, as a proxy for communication between an application operating on the client and a server, the local proxy operating in a same process as a browser operating on the client;
operating an application in a process different from the process of the local proxy;
receiving in the local proxy data transmitted by the application, and transmitting the data from the local proxy through the browser to the server; and
receiving by the local proxy processed data from the server through the browser, and transmitting the processed data to the application.

2. The method according to claim 1, further comprising:
in response to receiving a request for activating the application from a user, activating the local proxy.

3. The method according to claim 1, further comprising:
in response to receiving a request for activating the application from a user, loading the local proxy from the server and activating the loaded local proxy.

4. The method according to claim 1, wherein the local proxy is implemented using a software program related to an application operating on the browser.

5. The method according to claim 1, wherein the communication performed by the local proxy is performed using HyperText Transfer Protocol (HTTP).

6. The method according to claim 1, wherein the local proxy sets the application in the client as a communication destination and communicates only with the application.

7. A system for sharing communication information in a client-server system operated by a network application, comprising:
a browser that operates on a client; and
a local proxy that operates on the client, the local proxy operating as a proxy for communication between an application operating on the client and a server, the local proxy operating in a process of the browser operating on the client,
wherein the application operates in a process different from the process of the local proxy, and wherein
the local proxy includes:
a data receiving unit for receiving data transmitted by the application;
a data transmitting unit for transmitting the data to the server,
a processed data receiving unit for receiving processed data from the server, and
a processed data transmitting unit for transmitting the processed data to the application.

8. A computer program product for causing a computer to execute a method for sharing communication information in a client-server system operated by a network application, the computer program product comprising:
a local proxy that operates on a client as a proxy for communication between an application operating on the client and a server, and operating in a process of a browser operating on the client;
the application operating in a process different from the process of the local proxy;
the local proxy receiving data transmitted by the application, and transmitting the data to the server; and
the local proxy receiving processed data from the server, and transmitting the processed data to the application.
